(19) United States
(12) Patent Application Publication
(10) Pub. No.: US 2026/0179032 A1
(43) Pub. Date: Jun. 25, 2026

(54) FUTURE INVENTORY SYSTEM WITH ACCURATE DELIVERY PREDICTION

(71) Applicant: Walmart Apollo, LLC, Bentonville, AR (US)

(72) Inventors: Jitin Chemmannur, Bentonville, AR (US); Todd Gene Baumgartner, Bentonville, AR (US); Ujjwal Joshi, Bangalore (IN); Manishree, Bangalore (IN); Rakesh Haridasan, Palakkad (IN)

(21) Appl. No.: 18/999,830

(22) Filed: Dec. 23, 2024

(51) Int. Cl. G06Q 10/087; G06Q 10/0631

(52) U.S. Cl. CPC G06Q 10/087; G06Q 10/06311; G06Q 10/06316

(57) ABSTRACT

Examples provide a future inventory (FI) ordering system that enables orders of temporarily out-of-stock (OOS) items that are not currently on-hand at a fulfillment center (FC). A temporarily unavailable OOS item is made available for purchase with an extended estimated date of delivery (EEDD) as a future delivery (FD) item. A status indicator can be provided to distinguish FD items from currently in-stock items via a user interface (UI) device. Machine learning models are used to predict transit time, dwell time, and/or receiving time for the FD item using lane-specific data, dynamic extrinsic data, and other item-related data. The EEDD is predicted using the predicted transit time. A delivery notification including the EEDD for the FD item to the user via the UI device. Unloading of trailers containing FD items is prioritized at the FC to ensure timely delivery of FD items within the predicted EEDD.

### BACKGROUND

When an item is out-of-stock, a user is typically unable to order or obtain the item until the item is re-stocked on shelves. When shopping online, entries for items that are out-of-stock are typically grayed out or otherwise inaccessible for placement in a cart or basket. This can lead to frustration for users, dissatisfaction, as well as lost sales for retail providers where users may seek the out-of-stock item from a competitor or other source.

### SUMMARY

Some examples provide a system and method for future inventory (FI) ordering with accurate delivery date prediction. Temporarily out-of-stock (OOS) items which are currently in-transit to a fulfillment center (FC) or to be placed in-transit to the FC within a threshold time period, are identified and made available for purchase as a future delivery (FD) item. When an order for a FD item is received, the system predicts transit time from a source location of the FD item to the FC using lane-specific data associated with a route between the source location and the FC. The lane-specific data is data that is route-specific and carrier-specific, such as, but not limited to, historical transit times and dynamic extrinsic data associated with the route. An extended estimated delivery date (EEDD) for the FD item associated with the order is generated by a machine learning (ML) model using the predicted transit time. A delivery notification including the EEDD for the FD item is generated and presented to the user ordering the item via a user interface (UI) device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for future inventory with accurate delivery date estimation.

FIG. 2 is an exemplary block diagram illustrating a system for predicting delivery date of an out-of-stock (OOS) item in transit to a fulfillment center (FC).

FIG. 3 is an exemplary block diagram illustrating a system including a future inventory (FI) manager for predicting extended estimated delivery dates (EEDDs) using one or more machine learning (ML) models.

FIG. 4 is an exemplary block diagram illustrating a system for enabling ordering items that are currently OOS as if the items were currently in-stock.

FIG. 5 is an exemplary block diagram illustrating sources of FI for use in fulfilling future delivery (FD) item orders.

FIG. 6 is an exemplary block diagram illustrating a FC having a plurality of delivery vehicles for prioritization of unloading.

FIG. 7 is an exemplary block diagram illustrating a FI manager for managing both in-stock and temporarily OOS items.

FIG. 8 is an exemplary flow chart illustrating operation of the computing device to make temporarily OOS items available for purchase with currently in-stock items with accurate promised dates of delivery.

FIG. 9 is an exemplary flow chart illustrating operation of the computing device to predict an extended estimated delivery date for an FD item.

FIG. 10 is an exemplary flow chart illustrating operation of the computing device to provide a user ordering a FD item with an accurate estimated delivery date.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

When a user places an order online, the order is typically filled from a fulfillment node, such as a store or by drop ship vendor (DSV) that delivers items directly to a user from a distribution center (DC), warehouse, or other source. If the inventory for an item is not available at the fulfillment node, those items are shown as out-of-stock (OOS) on websites and shopping applications without regard for whether the OOS item is expected to be replenished soon by a shipment of items that is already in-transit to the fulfillment node. This leads to high OOS items on e-commerce websites, frustrated users, and opportunity loss as users migrate to competitors and other providers of the desired items.

Referring to the figures, examples of the disclosure enable placement of orders fulfilled by items that are temporarily out-of-stock (OOS) and in-route to a fulfillment center (FC) or to be placed in-route to the FC within a predetermined period of time. In some embodiments, temporarily OOS items that are in process of being shipped to the FC are identified and made available for purchase as a provisionally in-stock item that is not physically present at the FC but expected to be received at the FC within a threshold time period. This enables increasing item assortments available for purchase while reducing physical storage space required for storing items at the FC. This reduces physical storage space resource utilization while also reducing storage costs.

Other aspects provide an indicator on a webpage, such as a product information page or a search results page which indicates that temporarily OOS items are available for order with an extended (delayed) delivery date. In this manner, the system is able to increase inventory to include both physically in-stock items as well as provisionally in-stock items which are physically absent from the FC but expected to be received within a configurable threshold time period. This enables users to quickly and easily determine whether an item available for purchase is likely to arrive within the usual amount of time for in-stock items or whether there is a delay due to a predicted time delay associated with items that are currently in-transit to the FC for improved efficiency and ease of user interaction with the system.

Still other aspects provide a predicted transit time for future delivery (FD) items. A FD item is an item that is temporarily OOS and currently available for purchase via an e-commerce website or application. The system utilizes a trained machine learning (ML) model to predict the transit time from a source location of the supplier or distribution center (DC) to the FC using lane-specific data associated with the route between the source location and the FC. The lane-specific data includes historical transit times associated with the route and dynamic extrinsic data. Extrinsic data includes current conditions, such as weather conditions, seasonality, road conditions, traffic, holidays, etc. The predicted transit time enables provision of more accurate delivery dates to users requesting FD items.

The system, in some examples, provides an extended estimated delivery date (EEDD) for FD items being ordered by users. The EEDD is an estimated delivery date for an FD item that is temporarily OOS at the FC. The system generates the EEDD using the predicted transit time, as well as other data, such as predicted delays occurring before the delivery vehicle leaves the source location, receiving time at which the item is expected to arrive at the FC, as well as any other relevant data associated with the transport of the FD item from the source location to the destination FC. This enables the system to provide more accurate promised delivery dates to users, as well as reducing errors associated with item orders and item deliveries for improved efficiency.

In still other examples, the system provides a delivery notification including the EEDD for the FD item 160 to a user via a user interface (UI) device. This notifies the user as to the status of the FD item 160 as a temporarily unavailable item that is currently in-route with an expected delay in delivery, as well as providing the user with a more accurate promise date for receipt of the ordered FD item. This enables improved user efficiency via UI interaction, increased user interaction performance, and reduced errors in order data. The system further allows increasing the number of items available for order while improving the accuracy of order information and promised delivery dates provided to users with fewer errors and fewer order cancelations due to failure to timely delivery items while reducing physical space required for storing items made available for order from the FC for reduced storage costs.

The computing device is used in an unconventional way by reducing the number of item entries in a list or catalog of items available for order that are disabled due to an item being temporarily OOS. This reduces system resource usage consumed in providing and maintaining OOS items by increasing the number of in-stock and provisionally in-stock items within the list of items. The system further reduces errors in delivery dates generated by the system while improving accuracy of the order information provided to user, thereby improving the functioning of the underlying computing device.

In still other embodiments, enabling available inventory at an e-commerce website or e-commerce shopping application to include both physically in-stock items as well as temporarily out-of-stock items (provisionally in-stock items), provides greater flexibility of ordering options, more options for creating orders, publication of future inventory in-transit to an FC, visibility on in-transit inventory ETA, leveraging future inventory for increased inventory volume, as well as providing more relevant information to users on item arrival and future availability for improved user efficiency and satisfaction.

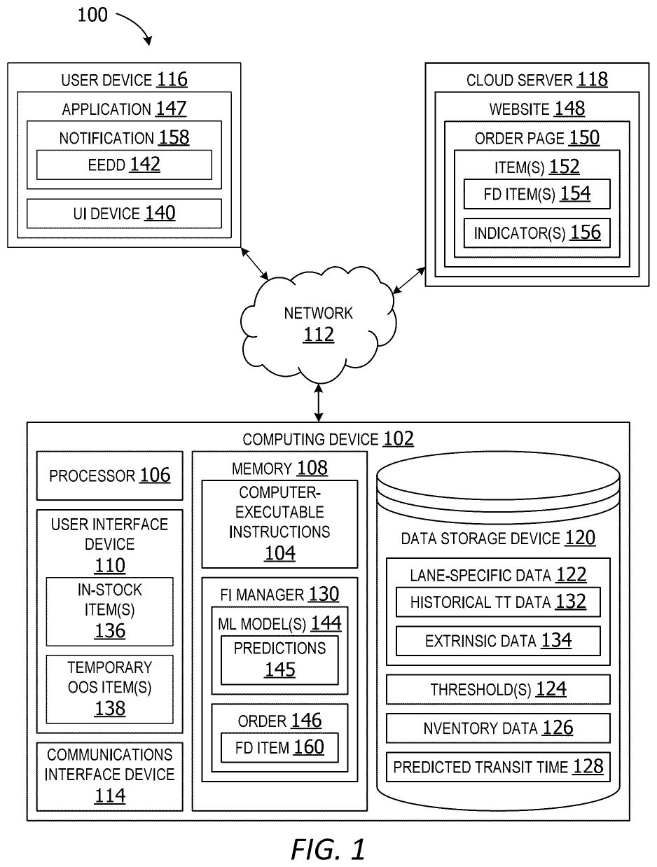

Referring again to FIG. 1, an exemplary block diagram illustrates a system 100 for future inventory (FI) with accurate delivery date estimation. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

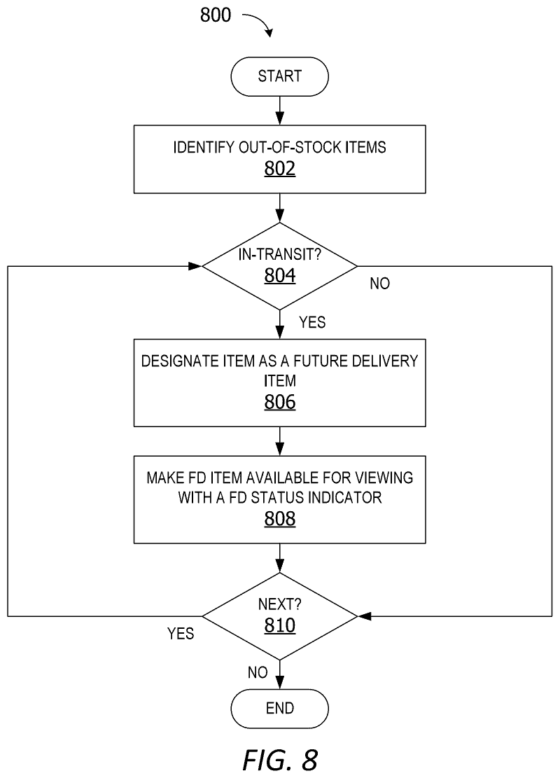

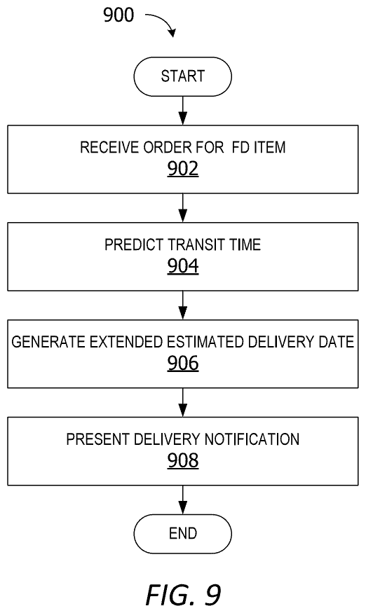

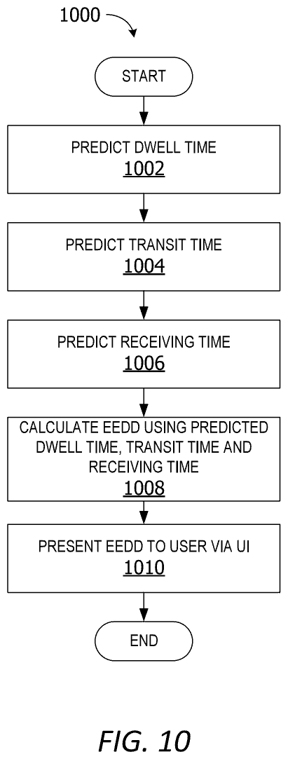

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 8, FIG. 9, and FIG. 10).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 120 for storing data, such as, but not limited to lane-specific data 122, one or more threshold(s) 124, inventory data 126, and/or predicted transit time 128 generated by a future inventory (FI) manager 130. The predicted transit time 128 is a ML generated predicted of estimated time of arrival (ETA) for an item that is currently in-transit or to be placed in-transit to a fulfillment node, such as an FC.

The lane-specific data 122 is data associated with a specific route of travel between a source location associated with a source of an item and a delivery vehicle transporting the item to the fulfillment center (FC). The lane-specific data 122 includes historical transit time (TT) data 132 from the source location to the destination location and/or extrinsic data 134 associated with the route. The historical TT data 132 includes travel time for a delivery vehicle to travel from the source location to the destination location on previous occasions in the past.

Extrinsic data 134 includes data associated with current conditions at the source location, along the route of travel between the source location and the destination location, and/or conditions at the destination location. The extrinsic data 134 includes weather conditions, holidays, temperature, road conditions, traffic conditions, road closures, bridge closures, power outages, seasonality data, etc.

The threshold(s) 124 include one or more user-configurable thresholds, such as, but not limited to, a threshold time period for an item to be placed on a delivery vehicle and/or a threshold time period for transport of the item from the source location to the destination location, such as, but not limited to, a fulfillment center. A fulfillment center is a destination location at which in-stock items are stored and/or displayed for order and/or purchase by a user. A fulfillment center can include a brick-and-mortar retail facility (store), an order fulfillment center, an order pickup locker location, or any other type of fulfillment center.

Inventory data 126 includes data associated with items that are in-stock at the fulfillment center and/or items which are out-of-stock (OOS). Items which are OOS can include temporarily OOS items and items that are expected to be OOS for an extended period of time. Temporarily OOS items are items which are not currently present at the FC, but which are either currently on-board a delivery vehicle and in-transit to the FC or scheduled to be placed on-board a transport vehicle for delivery to the FC within a threshold period of time. The threshold period of time is a threshold in the one or more threshold(s) 124.

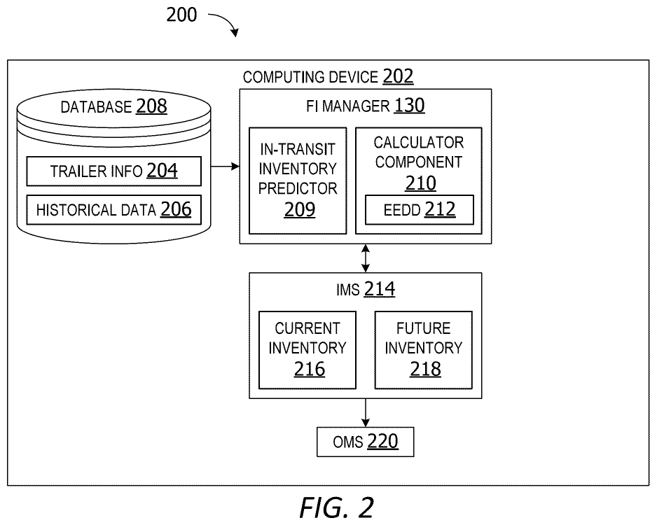

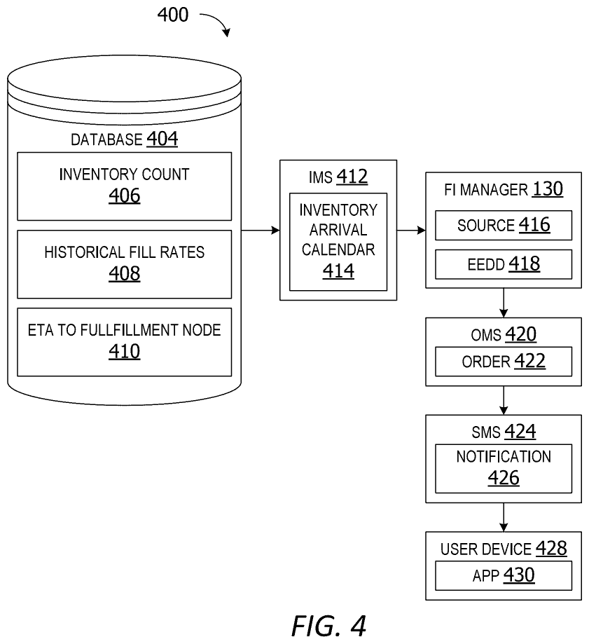

The data storage device 120 can include one or more different types of data storage devices, such as, for example, one or more rotating disks drives, one or more solid state drives (SSDs), and/or any other type of data storage device. The data storage device 120 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 120 includes a database, such as, but not limited to, the database 208 in FIG. 2 and/or the database 404 in FIG. 4 below.

The data storage device 120 in this example is included within the computing device 102, attached to the computing device, plugged into the computing device, or otherwise associated with the computing device 102. In other examples, the data storage device 120 includes a remote data storage accessed by the computing device via the network 112, such as a remote data storage device, a data storage in a remote data center, or a cloud storage.

The memory 108 in some examples stores one or more computer-executable components, such as, but not limited to, an FI manager 130. The FI manager 130, when executed by the processor 106 of the computing device 102, identifies one or more in-stock item(s) 136 and/or one or more temporary OOS item(s) 138 in inventory using inventory data 126. The temporary OOS item(s) 138 include one or more items physically present on a delivery vehicle or physically present at a source location where the item(s) are about to be placed on a delivery vehicle for delivery to a destination location, such as a fulfillment center. The in-stock item(s) 136 and the temporary OOS item(s) 138 are included in a list or catalog of available items presented to a user via a user interface (UI) device, such as, but not limited to, the user interface device 110 and/or the UI device 140 associated with the user device 116. A temporary OOS item that is ordered or selected for purchase is referred to as a future inventory or future delivery (FD) item for which an extended estimated delivery date (EEDD) 142 is calculated and provided to a user prior to completion of an order or purchase of the item.

If the FI manager 130 receives an order for a future delivery (FD) item that is temporarily out-of-stock (OOS), the FI manager 130 utilizes one or more machine learning (ML) models 144 for generating one or more prediction(s) 145 associated with the order 146. In some examples, the FI manager 130 utilizes a trained ML model in the ML model(s) to predict a transit time from the source location of the FD item 160 to the FC using lane-specific data associated with a route between the source location and the FC.

The source location is the location of the supplier or provider of the item. The source location includes, but is not limited to, the location of a distribution center (DC), a vendor, a warehouse, a store, or other source of an item. The predicted transit time 128 is generated by the ML model(s) 144 using the lane-specific data 122, including information about the delivery vehicle and/or the route being taken by the delivery vehicle. Information about the delivery vehicle includes a departure time of the delivery vehicle, weather conditions, historical transit time for other delivery vehicles following the same route from the source location to the destination location of the FC, etc.

The FI manager 130 generates the EEDD for the FD item 160 associated with the order 146 using the predicted transit time 128. The order 146 is an order to purchase one or more items from a provider associated with the FC. The order 146, in this example, includes at least one FD item. The order 146 is created by a user utilizing an application 147 associated with a retailer and/or a website 148 hosting an e-commerce shopping website for placing orders, including an order page 150 for creating and/or placing an order for one or more item(s) 152, including one or more FD item(s) 154. In some embodiments, the FI manager 130 provides a current (in-stock) inventory count and in-transit (provisionally in-stock) inventory count to the website 148 for presentation to a user.

Each FD item is associated with an indicator 156 identifying the FD item as an item that is temporarily OOS but still available for order or purchase with a longer delivery time than for other items which are physically in-stock at the FC.

The indicator(s) 156 include any type of indicator displayed to a user within a website via a UI device, such as, but not limited to, the user interface device 110 and/or the UI device 140. In some embodiments, the indicator(s) 156 include a graphical icon displayed in proximity to a name or other identifier representing each FD item and/or displayed within an item information page for each item. In other embodiments, the indicator includes text identifying the item as a FD item and/or a combination of a graphical icon with text identifying the item available for purchase with an extended delivery time. Thus, the user can create an order for an FD item using an application 147 on the user device and/or using a website 148 associated with the provider/merchant offering the item for order.

In this example, the website 148 is implemented on the cloud server 118 and accessed by a user associated with the user device 116 via the network 112. However, in other embodiments, the website 148 is hosted on a computing device, such as, but not limited to, the computing device 102.

The present a delivery notification 158, including the EEDD for the FD item 160, to a user via a user interface (UI) device, such as, but not limited to, the user interface device 110 and/or the UI device 140. The notification 158 is any type of notification. The delivery notification 158 optionally includes text description of the FD item 160, an image of the FD item 160, the EEDD 142, as well as any other appropriate information.

In this non-limiting example, the FI manager 130 is implemented on the computing device 102. However, the embodiments are not limited to implementing the FI manager 130 on a computing device. In other embodiments, the FI manager 130 is implemented on a cloud server, such as, but not limited to, the cloud server 118.

The system 100 enables order fulfillment using both on-hand inventory (items currently in-stock) as well as future inventory (items in-transit/inbound which have not yet arrived at the fulfillment node. Future Inventory is the ability to take online orders against in-transit inventory to a fulfillment node. If an item is not available at the fulfilment node but has an in-transit inventory, that item and quantity is shown as in-stock online (website and application). Users can place orders against future inventory. The system accounts for transit time, time from the source to the fulfillment center when generating the order delivery date/promised date by accounting for the lead time it takes for the item to arrive at the fulfillment node.

FIG. 2 is an exemplary block diagram illustrating a system 200 for predicting delivery date of an out-of-stock (OOS) item in transit to a fulfillment center (FC). The system 200 includes an FI manager 130 implemented on a computing device 202. The computing device 202 is a device, such as, but not limited to, the computing device 102 and/or the user device 116 in FIG. 1. The FI manager 130 utilizes trailer information (info) 204 and/or historical data 206 associated with an FD item that is in-transit to an FC. The trailer info 204 is information associated with the delivery vehicle transporting the FD item. The trailer info includes data such as, but not limited to, departure time a delivery vehicle left a source location, current delivery vehicle location, route being taken by the delivery vehicle, etc. In some embodiments, the trailer info 204 includes an ETA of a delivery vehicle carrying an FD item to a fulfillment node. The ETA is provided to the FI manager 130. In other examples, the trailer info 204 includes purchase order updates and/or dynamic truck transit updates identifying locations of a delivery vehicle in real-time.

The historical data 206 includes historical transit time data associated with previous delivery vehicles transporting items from the same source location on the same or similar route to the FC, such as, but not limited to, the historical TT data 132 in FIG. 1. The trailer info 204 and/or the historical data 206 in this example is obtained from a database 208. However, in other examples, the trailer info 204 and/or the historical data 206 is obtained from a cloud server or other remote source via a network, such as, but not limited to, the network 112 in FIG. 1.

The FI manager 130, in some examples, includes an in-transit inventory predictor 209. The in-transit inventory predictor identifies OOS items that are currently in-transit to the FC and/or expected to be placed in-transit to the FC within a threshold time period, such as within twenty-four hours. In other examples, the threshold time period is two days instead of one day. In still other examples, the threshold time period is twelve hours, thirty-six hours, three days, or any other user configurable amount of time.

For example, if the threshold period of time is two days, the future inventory item counts include temporarily OOS items that are in-transit and/or expected to be delivered to the fulfillment node (FC) within the next forty-eight hours. In this example, items in-transit that are not expected to arrive at the FC for three days are not included in the future inventory item count.

The in-transit inventory predictor 209, in some embodiments, uses historical data such as average historical variance in ETA and applies historical fill rates to generate the predicted transit time for a delivery vehicle. Inventory arrival dates are stored in IMS. In an example, when a user searches for an item via a catalog search, the system checks both current inventory and future inventory for the desired item. The system only considers future inventory if the item is not available in current inventory. In other words, if an instance of a desired item is currently in-stock at the FC, the system does not utilize future inventory to complete the order. If future inventory is leveraged to complete the order, the system utilizes the predicted transit time values having the greatest confidence to generate the EEDD for the order. The user provide shipment details, including the EEDD at checkout. The order is placed on hold until the predicted FD item arrival date.

The calculator component 210 is a component for calculating an EEDD 212. The EEDD 212 is an extended estimated delivery date associated with an FD item, such as, but not limited to, the EEDD 142 in FIG. 1. The calculator component 210 in some embodiments includes one or more trained ML models for calculating the EEDD 142 based on one or more predictions, such as, but not limited to, the transit time prediction for the delivery vehicle transporting the FD item.

An inventory management system (IMS) 214 manages information associated with current inventory 216 and future inventory 218. Current inventory includes items that are physically in-stock and present at the FC. Future inventory 218 includes FD items that are currently OOS temporarily and in-transit to the FC or to be placed in-transit to the FC within a threshold time period.

In some embodiments, the IMS 214 receives future inventory 218 data from the FI manager 130. In other words, the FI manager in-transit inventory predictor 209 identifies temporary OOS items that are in-transit or soon to be in-transit and sends updates identifying future inventory items to the IMS 214. In this manner, the IMS 214 manages both in-stock items as well as temporarily OOS items as if both types of items were currently in-stock. An order management system (OMS) 220 manages orders for both in-stock items as well as FD items that are temporarily OOS using in-transit inventory data received from the FI manager 130.

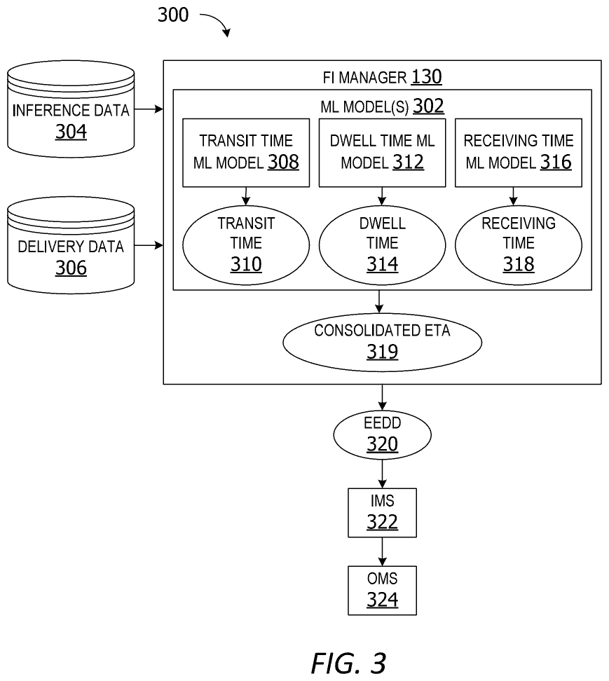

FIG. 3 is an exemplary block diagram illustrating a system 300 including a FI manager 130 for predicting extended estimated delivery dates (EEDDs) using one or more machine learning (ML) models. The FI manager 130 includes one or more ML model(s) 302. The ML model(s) 302 include pretrained ML models for predicting transit time and/or EEDD 320, such as, but not limited to, the ML model(s) 144 in FIG. 1. The ML model(s) 302 utilize lane-specific data and item-specific data, such as, but not limited to, inference data 304 and delivery data 306. The inference data 304 is data inferred from the lane-specific data, including dynamic extrinsic data. The delivery data 306 is data associated with the delivery vehicle transporting the FD item to the FC, such as, but not limited to, the departure time, departure location, current location of the delivery vehicle, route being traveled by the delivery vehicle, speed limit(s) for roads traversed by the delivery vehicle, traffic conditions, etc.

The ML model(s) 302 in some embodiments, include a transit time (TT) ML model 308. The TT ML model predicts transit time 310 for a delivery vehicle transporting the FD item(s). In other examples, the ML model(s) include a dwell time (DW) ML model 312. The DW ML model 312 generates a predicted dwell time 314 for the delivery vehicle. In still other examples, a receiving time (RT) ML model 316 is a trained ML model that predicts receiving time 318 for one or more FD items. The transit time 310, dwell time 314, and receiving time 318 are used to generate a consolidated ETA 319 by the ML model(s) 302. The consolidated ETA 319 is used to calculate an accurate EEDD 320. The EEDD 320 is provided to an IMS 322 and/or an OMS 324 for utilization in managing FI orders. The IMS 322 is an inventory management system such as, but not limited to, the IMS 214 in FIG. 2. The OMS 324 is an order management system, such as, but not limited to, the OMS 220 in FIG. 2.

Referring now to FIG. 4, an exemplary block diagram illustrating a system 400 for enabling ordering items that are currently OOS as if the items were currently in-stock is shown. In this example, a database 404 stores future inventory related data, such as, but not limited to, inventory count 406 associated with the number of FD items in FI, historical fill rates 408 for inventory items, and/or estimated time to arrival (ETA) of FD items to a fulfillment node 410, such as a FC. The database 404 is a device for storing data, such as, but not limited to, the database 208 in FIG. 2. In some embodiments, inventory count for every item is provided based on historical fill rates for replenishment orders from a supplier or other source.

In this example, an IMS 412 maintains an inventory arrival calendar 414. The calendar is used to track current and future inventory ETAs. The IMS 412 is an inventory management system such as, but not limited to, the IMS 214 in FIG. 2 and/or the IMS 322 in FIG. 3.

The FI manager 130 identifies a source 416 for an item that is temporarily OOS and calculates an EEDD 418 for the item based on lane-specific data for the item. The EEDD 418 is provided to an OMS 420. The OMS is an order management system, such as, but not limited to, the OMS 220 in FIG. 2 and/or the OMS 324 in FIG. 3. The OMS 420 utilizes the EEDD 418 to update an FD item order 422. The order 422 is an order requesting or purchasing an FD item, such as, but not limited to, the order 146 in FIG. 1.

The order information, including the EEDD 418, is provided to a store management system (SMS) 424. The SMS generates a notification 426 to the user creating the order 422. In this example, the order 422 is created via an e-commerce application 430. The notification 426 is a notification, such as, but not limited to, the notification 158. The notification 426 is presented to the user via an application implemented on a user device 428. The application 430 is an application for purchasing items and/or creating FD item orders, such as, but not limited to, the application 147 in FIG. 1.

In this example, the SMS generates the notification 426. In other examples, the FI manager 130 creates the notification and transmits the notification to the SMS 424 and/or transmits the notification directly to the user device 428 for output to the user.

In other embodiments, the FI manager 130 determines the most optimal fulfillment node and/or delivery date based on the current inventory of in-stock items and the future inventory of provisionally in-stock items snapshot provided by the IMS 412. In other words, the FI manager 130 identifies a “best” supplier from one or more suppliers available to provide the OOS item(s) to the FC using the current inventory data, including future inventory data. The OMS 420 holds the order from dropping to the SMS 424 until in-transit future inventory arrives at the FC. Once the FD item arrives at the FC, the item is shipped to the final destination, such as a business or residence associated with a user that created the order. In this example, the order is created via the application 430 implemented on the user device 428.

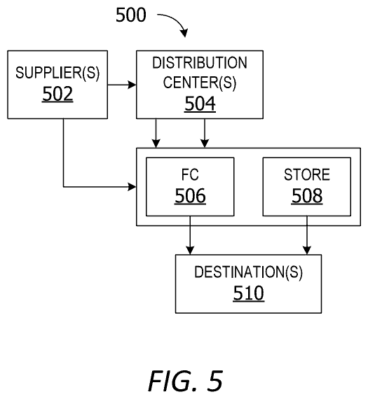

FIG. 5 is an exemplary block diagram illustrating sources of FI for use in fulfilling future delivery (FD) item orders. In this example, the system 500 includes one or more supplier(s) 502 of one or more item(s), such as, but not limited to, a FD item. A supply in the supplier(s) 502 includes any type of supplier of goods, such as, but not limited to, a vendor. The supplier(s) 502 provide item(s) to one or more distribution center(s) 504 or other destinations, such as a fulfillment center (FC) 506 and/or a store 508. A distribution center (DC) can include an ambient (SDC) supplying item(s) to stores and/or import DC receiving imported items from one or more suppliers of imported items. An import DC provides items to the SDC and/or a FC.

The store 508 is a retail facility providing items to customers, such as, but not limited to, groceries, hardware, pet suppliers, apparel, etc. Supplier(s) 502 and/or distribution center(s) 504 provide item(s) to the FC 506 and/or the store 508. The store and/or the FC provide items to one or more destination(s) 510, such as a customer residence.

The FI manager predicts an estimated time of arrival (ETA) to respective nodes, such as a DC and/or a final fulfillment node, such as the FC 506 and/or the store 508. The system enables product enhancements to aid in-transit ordering, such as status indicators and/or EEDD notifications. The system enables orders against in-transit inventory that is in-route from suppliers and/or DCs to the final fulfillment node.

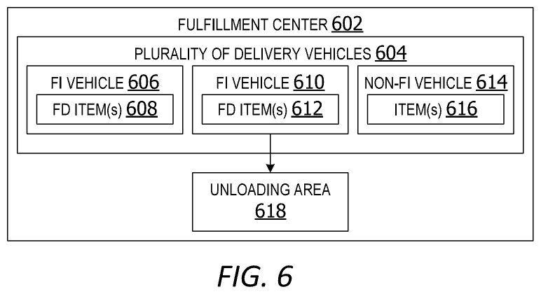

Turning now to FIG. 6, an exemplary block diagram illustrating a fulfillment center 602 having a plurality of delivery vehicles 604 for prioritization of unloading is shown. In this example, a first FI vehicle 606 is a delivery vehicle that contains one or more FD item(s) 608 and a second FI vehicle 610 is another delivery vehicle that also contains one or more FD item(s) 612. A non-FI vehicle 614 is a delivery vehicle which contains one or more item(s) 616. However, the non-FI vehicle 614 does not contain any FD items.

In this example, three vehicles are waiting for items to be removed or unloaded from their trailers at an unloading area 618. The system prioritizes unloading of FI vehicles containing FD items to expedite delivery of these FD items to users that have already ordered and/or purchased these items. In this example, the FI vehicle 606 and the FI vehicle 610 are prioritized for unloading ahead of the non-FI vehicle 614.

Likewise, where two or more delivery vehicles include FD items, the system prioritizes the vehicle having the highest quantity of FD items on-board for unloading. In this example, if the FI vehicle 606 contains more FD items than the FI vehicle 610, the FI vehicle 606 is prioritized ahead of the FI vehicle 610. In this example, the FI vehicle 606 is unloaded at the unloading area first, the FI vehicle 610 is unloaded at the unloading area second, and the non-FI vehicle 614 is unloaded third (last).

In this example, three delivery vehicles (trucks) are assigned an unloading priority. However, the embodiments are not limited to three delivery vehicles. In other embodiments, the system prioritizes two vehicles, as well as four or more vehicles for unloading at an FC.

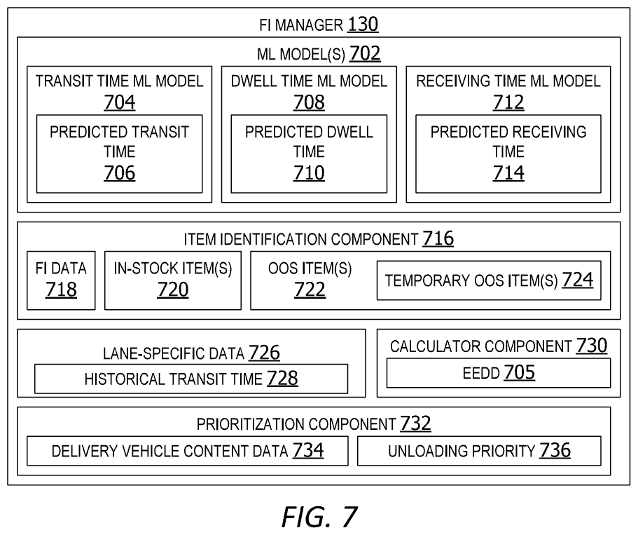

FIG. 7 is an exemplary block diagram illustrating a FI manager 130 for managing both in-stock and temporarily OOS items. The FI manager 130 utilizes one or more trained ML model(s) 702 to generate the predicted EEDD 705. The ML model(s) 702 in some embodiments includes a trained transit item ML model 704 for generating a predicted transit time 706 from a supplier source location to the final fulfillment node (destination location). The transit time ML model is an artificial intelligence (AI) model trained using labeled training data to predict the amount of time it is likely to take for a delivery vehicle to transport an item from the source location to the FC using historical transit times for the same route, departure time, and extrinsic data, such as weather conditions.

A dwell time ML model 708 is a trained ML model for predicting dwell time. The predicted dwell time 710 is an amount of time an item remains stationary at a given location, such as the source location, prior to departure of the delivery truck on which the item is being shipped. A receiving time ML model 712, in some embodiments, is a trained ML model for predicting a date and/or time at which an item is predicted to arrive at a destination location, such as, but not limited to, the FC.

In some embodiments, the FI manager 130 includes an item identification component 716. The item identification component 716 identifies items that are temporarily OOS based on future inventory (FI) data 718. In-stock item(s) 720 include items currently in-stock at the fulfillment node, such as the FC. The OOS item(s) 722 include items that are OOS and not in-route to the FC as well as temporary OOS item(s) 724 that are OOS at the FC but in-route to the FC or soon to in-route to the FC. An item is soon to be in-route if it is not currently in-route but is expected to be in-route within a threshold amount of time.

The FI manager 130 uses lane-specific data 726 to predict the EEDD 705. The lane-specific data 726 refers to data associated with a transportation lane used to transport an item from a source to an FC or other destination. The lane-specific data 726 includes historical transit time 728 for other delivery vehicles transporting items from the same source to the same destination along the same route.

A calculator component 730 is a component for calculating the EEDD 705, such as, but not limited to, the calculator component 210 in FIG. 2. The calculator component 730 uses item specific data and ML model predictions, such as, but not limited to, the predicted transit time 706, the predicted dwell time 710, and/or the predicted receiving time 714. The item-specific data includes data such as, but not limited to, nearest supplier (source location) for obtaining the item, departure date and/or time of a delivery truck containing an instance of the FD item, and/or carrier transporting the FD item to the FC. The EEDD 705 is an item-specific EEDD which is calculated in real-time when a user is creating an order including a FD item.

In some embodiments, the FI manager 130 includes a prioritization component 732. The prioritization component 732 assigns an unloading priority 736 to each delivery vehicle in a queue for unloading at an FC. The prioritization component 732 determines priority for unloading delivery vehicles based on a number of FD items on-board each delivery vehicle in a queue for unloading. The prioritization component 732 utilizes delivery vehicle content data 734 to determine the priority for each vehicle. The delivery vehicle content data 734 includes a manifest or list of items on-board each delivery truck in the unloading queue at the FC.

FIG. 8 is an exemplary flow chart illustrating operation of the computing device to make temporarily OOS items available for purchase with currently in-stock items with accurate promised dates of delivery. The process 800 shown in FIG. 8 is performed by a FI manager component, executing on a computing device, such as the computing device 102 or the user device 116 in FIG. 1.

The process begins by identifying out-of-stock items at 802. An out-of-stock item is an item that is physically absent from inventory at an FC, such as, but not limited to, the OOS item(s) 722 in FIG. 7. A determination is made whether an OOS item is in-transit to the FC at 804. If not, a determination is made whether a next OOS item is identified at 810. If an OOS item is determined to be in-transit at 804, the FI manager designates the item as a future delivery item at 806. The FI manager makes the FD item available for viewing with a FD status indicator at 808. The FD status indicator is an indicator identifying temporarily OOS items that are in-transit or soon to be in-transit to the FC, such as, but not limited to, the indicator(s) 156. A determination is made whether a next OOS item is identified at 810. If not, the process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

Referring now to FIG. 9, an exemplary flow chart illustrating operation of the computing device to predict an extended estimated delivery date for an FD item is shown. The process 900 shown in FIG. 9 is performed by a FI manager component, executing on a computing device, such as the computing device 102 or the user device 116 in FIG. 1.

The process begins by receiving an order for an FD item at 902. The order is an order created via an application or an e-commerce website, such as, but not limited to, the order 146 in FIG. 1. The FI manager predicts transit time for the FD item at 904. The FI manager generates an extended estimated delivery date at 906. The FI manager presents a delivery notification to the user creating the order at 908. The notification is a notification including the extended estimated delivery date, such as, but not limited to, the notification 158 in FIG. 1. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

FIG. 10 is an exemplary flow chart illustrating operation of the computing device to manage self-returns of items. The process 1000 shown in FIG. 10 is performed by a FI manager component, executing on a computing device, such as the computing device 102 or the user device 116 in FIG. 1.

The process begins by predicting dwell time for an FD item at 1002. The dwell time is a predicted amount of time an item is expected to remain at the source location or other location while not in transit and/or the amount of time the item remains on a stationary delivery vehicle that has not yet departed from the source location (supplier), such as, but not limited to, the predicted dwell time 710 in FIG. 7. The FI manager predicts transit time for the FD item at 1004. The predicted transit time is the amount of time the FD item is predicted to be in-route to the FC from the source location on-board a delivery vehicle, such as, but not limited to, the predicted transit time 706 in FIG. 7. The FI manager predicts a receiving time at 1006. The receiving time is the date and/or time the FD item is predicted to arrive at the FC, such as, but not limited to, the predicted receiving time 714 in FIG. 7. The FI manager calculates EEDD using the predicted dwell time, predicted transit time, and the predicted receiving time at 1008. The FI manger presents the predicted EEDD to the user via a UI at 1010. The UI is a user interface, such as, but not limited to, the user interface device 110 and/or the UI device 140 in FIG. 1. The process terminates thereafter.

While the operations illustrated in FIG. 10 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 10.

### Additional Examples

In some examples, the system utilizes innovative ML models to refine truck transit ETA obtained from external systems, employ an ensemble of models to predict dwell and receiving times at FCs, and determine when the FD item(s) will be shelved. This refined ETA is then employed by an IMS system to update inventory information on an e-commerce website or application for customer purchase.

In other embodiments, the system enables order capture against future inventory in-transit to FCs, including stores and DSVs. The system predicts extended estimated delivery date for future inventory which considers transit time, dwell & receiving times of the FCs and sends the consolidated ETA to the downstream system (IMS). The system provides near real-time visibility to supplier's in-transit inventory positions for a time period, such as, but not limited to, the next thirty days. The changes are immediately reflected across all inventories, sourcing and .com systems. Changes are immediately reflected across all inventories, sourcing and IMS systems. Users are able to view both in-stock items as well as out of stock items which are in-transit. Customers can search/view future inventory, select/purchase in-transit items, and add those OOS items to the cart without any experience difference from in-stock. The EEDD is calculated by extending the item arrival days using predicted transit times calculated based on lane-specific data, such as seasonality, weather, historical transit times for carrier, etc.

Other embodiments provide current trailer unload prioritization (TUP) logic at the FC is enhanced to factor in future inventory (FI) current orders. Trailers with items of FI orders are prioritized over others. If there are two trucks waiting for unloading and one truck holds FI orders, the truck with the FI orders is prioritized for unloading ahead of the truck/trailer without FI orders.

In still other embodiments, ML models are used to predict transit times and promise dates for future inventory items. This enables users to place an online order that will be fulfilled by inventory that is not on-hand. When a user places an order online, the order is fulfilled using both available (on-hand) inventory at fulfillment centers and inventory that is in-transit to the fulfillment node. This is enabled by having predictive capabilities on an accurate ETA for inbound items, controls and levers for ring fencing, item and node selection as well as smart sourcing logic to determine the best place and path to fulfill the demand.

The system, in other embodiments, provides users with the ability to fulfill an ecommerce order from inventory that is inbound into a fulfillment node. When customers or other users place an order online, multiple systems within supply chain work together to determine when the item for that order is going to arrive at a particular location, which can be a fulfillment center, warehouse or a store or a club. The sourcing engine uses these signals to pick the optimal location to fulfill the demand with trade off against nodes that may or may not carry these items.

The intelligence built across supply chain systems, the data science models, controls and levers in place to ring fence inventory, analytics, activate and de-active nodes and items, measures and probability of fulfilling an item or an entire order at item quantity level, ability to capture supplier inventory in near real-time etc. are novel features that were developed as part of this invention. The system can further enable vertical integration with supplier eco-system to understand the manufacturing process, their integrated planning for long term forecasting, and/or smart logic to predict demand fulfillment patterns.

With this system, if an item is not available at the fulfilment node but has an in-transit inventory, that item and quantity is shown as provisionally in-stock on the ecommerce website. Users can place orders against it. Users are provided accurate delivery dates for in-transit items by accounting for the lead time it takes for the item to arrive at the fulfillment node for improved online user experience and fewer item outs, increased revenue, and reduction in system resource usage consumed by managing OOS items on the website or shopping application.

In other embodiments, the FI manager is a smart ETA system that predicts the in-transit, dwell time, and receiving times of the FCs and sends the consolidated ETA to the downstream system (IMS). The consolidated ETA is used to generate the EEDD. The system provides accurate ETA prediction using ML based ETA prediction on trailer level real time information to provide the best accurate ETAs. Other retailer predictions are on demand forecasts, leading to lot of variability. Exact delivery promise (EEDD) is shown to the member which takes the in-transit days into account along with the fulfillment time. To protect against the ETA inaccuracy, the system ensures that the trailers containing future inventory orders are unloaded first to enhance sourcing with the fastest speed and lowest cost. The system ensures that the most optimal node across all omni channels (FCs/DSVs/stores) is chosen. This ensures that the overall cost is low, and speed is highest.

Alternatively, or in addition to the other examples described herein, examples include any combination of the following:
predict, by a third ML model, dwell time for the FD item, wherein the EEDD is calculated using the predicted transit time and the predicted dwell time;
predict, by a fourth ML model, receiving time for the FD item at the FC, wherein the EEDD is calculated using the predicted transit time, the predicted dwell time, and the predicted receiving time;
identify a first delivery vehicle in a plurality of delivery vehicles at the FC containing at least one FD item;
prioritize unloading the first delivery vehicle ahead of a second delivery vehicle in the plurality delivery vehicles, wherein the second delivery vehicle fails to contain any FD items;
identify a plurality of delivery vehicles at the FC, wherein the plurality of

delivery vehicles comprises a first delivery vehicle and a second delivery vehicle containing at least one FD item;
identify a first number of FD items on-board the first delivery vehicle and a second number of FD items on-board the second delivery vehicle;
schedule unloading of the first delivery vehicle prior to unloading of the second delivery vehicle responsive to the first number of FD items on-board the first delivery vehicle exceeding the second number of FD items on-board the second delivery vehicle;
schedule unloading of the second delivery vehicle prior to unloading of the first delivery vehicle responsive to the second number of FD items on-board the second delivery vehicle exceeding the first number of FD items on-board the first delivery vehicle;
generate a FD status indicator associated with an entry for a FD item within an item order page, wherein the FD status indicator identifies the FD item as a temporarily OOS item which is available to order with a delayed future date of

delivery;
present a list of a plurality of items available for order via a website;
add a graphical FD status indicator associated with each FD item in the plurality of items;
add a graphical non-FD status indicator associated with each item in the plurality of items that are currently available at the FC;
receiving an order for a future delivery (FD) item that is temporarily out-of-stock (OOS), wherein the FD item is currently in-transit to a fulfillment center (FC) or scheduled to be placed in-transit to the FC within a threshold time period;
predicting, by a first machine learning (ML) model, a transit time from a source location of the FD item to the FC using lane-specific data associated with a route between the source location and the FC, the lane-specific data comprising historical transit times and dynamic extrinsic data;
generating, by a second ML model, an extended estimated delivery date (EEDD) for the FD item associated with the order using the predicted transit time;
presenting a delivery notification including the EEDD for the FD item to a user via a user interface (UI) device;
predicting, by a dwell time (DT) machine learning (ML) model, DT for the FD item, wherein the EEDD is calculated using the predicted transit time and the predicted dwell time;
predicting, by a receiving time (RT) ML model, an RT for the FD item at the

FC, wherein the EEDD is calculated using the predicted transit time and the predicted receiving time;
identifying a first delivery vehicle in a plurality of delivery vehicles at the FC containing at least one FD item;
prioritizing unloading the first delivery vehicle ahead of a second delivery vehicle in the plurality delivery vehicles, wherein the second delivery vehicle fails to contain any FD items;
identifying a plurality of delivery vehicles at the FC, wherein the plurality of delivery vehicles comprises a first delivery vehicle and a second delivery vehicle containing at least one FD item;
identifying a first number of FD items on-board the first delivery vehicle and a second number of FD items on-board the second delivery vehicle;
scheduling unloading of the first delivery vehicle prior to unloading of the second delivery vehicle responsive to the first number of FD items on-board the first delivery vehicle exceeding the second number of FD items on-board the second delivery vehicle;
scheduling unloading of the second delivery vehicle prior to unloading of the first delivery vehicle responsive to the second number of FD items on-board the second delivery vehicle exceeding the first number of FD items on-board the first delivery vehicle;
generating a FD status indicator associated with an entry for a FD item within an item order page, wherein the FD status indicator identifies the FD item as a temporarily OOS item which is available to order with a delayed future date of delivery;
presenting a list of a plurality of items available for order via a website;
adding a graphical FD status indicator associated with each FD item in the plurality of items;
adding a graphical non-FD status indicator associated with each item in the plurality of items that are currently available at the FC.

At least a portion of the functionality of the various elements in FIG. 1, FIG. 2, FIG. 3, FIG. 4, and FIG. 7 can be performed by other elements in FIG. 1, FIG. 2, FIG. 3, FIG. 4, and FIG. 7, or an entity (e.g., processor 106, web service, server, application program, computing device, etc.) not shown in FIG. 1, FIG. 2, FIG. 3, FIG. 4, and FIG. 7.

In some examples, the operations illustrated in FIG. 8, FIG. 9, and FIG. 10 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of predicting an accurate delivery date for temporarily out-of-stock items, the method comprising receiving an order for a future delivery (FD) item that is temporarily out-of-stock (OOS), wherein the FD item is currently in-transit to a fulfillment center (FC) or scheduled to be placed in-transit to the FC within a threshold time period; predicting, by a first machine learning (ML) model, a transit time from a source location of the FD item to the FC using lane-specific data associated with a route between the source location and the FC, the lane-specific data comprising historical transit times and dynamic extrinsic data; generating, by a second ML model, an extended estimated delivery date (EEDD) for the FD item associated with the order using the predicted transit time; and presenting a delivery notification including the EEDD for the FD item to a user via a user interface (UI) device.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein. The examples illustrated and described herein as well as examples not specifically described herein but within the scope of aspects of the disclosure constitute exemplary means for future inventory ordering with accurate delivery prediction. For example, the elements illustrated in FIG. 1, FIG. 2, FIG. 3, FIG. 4 and FIG. 7, such as when encoded to perform the operations illustrated in FIG. 8, FIG. 9, and FIG. 10, constitute exemplary means for receiving an order for a future delivery (FD) item that is temporarily out-of-stock (OOS), wherein the FD item is currently in-transit to a fulfillment center (FC) or scheduled to be placed in-transit to the FC within a threshold time period; exemplary means for predicting, by a first machine learning (ML) model, a transit time from a source location of the FD item to the FC using lane-specific data associated with a route between the source location and the FC, the lane-specific data comprising historical transit times and dynamic extrinsic data; exemplary means for generating, by a second ML model, an extended estimated delivery date (EEDD) for the FD item associated with the order using the predicted transit time; and exemplary means for presenting a delivery notification including the EEDD for the FD item to a user via a user interface (UI) device.

Other non-limiting examples provide one or more computer storage devices having a first computer-executable instructions stored thereon for providing delivery prediction for provisionally in-stock items that are in-route to a fulfillment node. When executed by a computer, the computer performs operations including receiving an order for a future delivery (FD) item that is temporarily out-of-stock (OOS), wherein the FD item is currently in-transit to a fulfillment center (FC) or scheduled to be placed in-transit to the FC within a threshold time period; predicting, by a first machine learning (ML) model, a transit time from a source location of the FD item to the FC using lane-specific data associated with a route between the source location and the FC, the lane-specific data comprising historical transit times and dynamic extrinsic data; generating, by a second ML model, an extended estimated delivery date (EEDD) for the FD item associated with the order using the predicted transit time; and presenting a delivery notification including the EEDD for the FD item to a user via a user interface (UI) device.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of′ ”only one of′ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for future inventory (FI) ordering with accurate delivery date prediction, the system comprising:
a processor; and
a computer-readable medium storing instructions that are operative upon execution by the processor to:
receive an order for a future delivery (FD) item that is temporarily out-of-stock (OOS), wherein the FD item is currently in-transit to a fulfillment center (FC) or scheduled to be placed in-transit to the FC within a threshold time period;
predict, by a first machine learning (ML) model, a transit time from a source location of the FD item to the FC using lane-specific data associated with a route between the source location and the FC, the lane-specific data comprising historical transit times and dynamic extrinsic data;
generate, by a second ML model, an extended estimated delivery date (EEDD) for the FD item associated with the order using the predicted transit time; and
present a delivery notification including the EEDD for the FD item to a user via a user interface (UI) device.

2. The system of claim 1, wherein the instructions are further operative to:
predict, by a third ML model, dwell time for the FD item, wherein the EEDD is calculated using the predicted transit time and the predicted dwell time.

3. The system of claim 2, wherein the instructions are further operative to:
predict, by a fourth ML model, receiving time for the FD item at the FC, wherein the EEDD is calculated using the predicted transit time, the predicted dwell time, and the predicted receiving time.

4. The system of claim 1, wherein the instructions are further operative to:
identify a first delivery vehicle in a plurality of delivery vehicles at the FC containing at least one FD item; and
prioritize unloading the first delivery vehicle ahead of a second delivery vehicle in the plurality delivery vehicles, wherein the second delivery vehicle fails to contain any FD items.

5. The system of claim 1, wherein the instructions are further operative to:
identify a plurality of delivery vehicles at the FC, wherein the plurality of delivery vehicles comprises a first delivery vehicle and a second delivery vehicle containing at least one FD item;
identify a first number of FD items on-board the first delivery vehicle and a second number of FD items on-board the second delivery vehicle;
schedule unloading of the first delivery vehicle prior to unloading of the second delivery vehicle responsive to the first number of FD items on-board the first delivery vehicle exceeding the second number of FD items on-board the second delivery vehicle; and
schedule unloading of the second delivery vehicle prior to unloading of the first delivery vehicle responsive to the second number of FD items on-board the second delivery vehicle exceeding the first number of FD items on-board the first delivery vehicle.

6. The system of claim 1, wherein the instructions are further operative to:
generate a FD status indicator associated with an entry for a FD item within an item order page, wherein the FD status indicator identifies the FD item as a temporarily OOS item which is available to order with a delayed future date of delivery.

7. The system of claim 1, wherein the instructions are further operative to:
present a list of a plurality of items available for order via a website;
add a graphical FD status indicator associated with each FD item in the plurality of items; and
add a graphical non-FD status indicator associated with each item in the plurality of items that are currently available at the FC.

8. A method for future inventory (FI) ordering with accurate delivery date prediction, the method comprising:
receiving an order for a future delivery (FD) item that is temporarily out-of-stock (OOS), wherein the FD item is currently in-transit to a fulfillment center (FC) or scheduled to be placed in-transit to the FC within a threshold time period;
predicting, by a first machine learning (ML) model, a transit time from a source location of the FD item to the FC using lane-specific data associated with a route between the source location and the FC, the lane-specific data comprising historical transit times and dynamic extrinsic data;
generating, by a second ML model, an extended estimated delivery date (EEDD) for the FD item associated with the order using the predicted transit time; and
presenting a delivery notification including the EEDD for the FD item to a user via a user interface (UI) device.

9. The method of claim 8, further comprising:
predicting, by a dwell time (DT) machine learning (ML) model, DT for the FD item, wherein the EEDD is calculated using the predicted transit time and the predicted dwell time.

10. The method of claim 8, further comprising:
predicting, by a receiving time (RT) ML model, an RT for the FD item at the FC, wherein the EEDD is calculated using the predicted transit time and the predicted receiving time.

11. The method of claim 8, further comprising:
identifying a first delivery vehicle in a plurality of delivery vehicles at the FC containing at least one FD item; and
prioritizing unloading the first delivery vehicle ahead of a second delivery vehicle in the plurality delivery vehicles, wherein the second delivery vehicle fails to contain any FD items.

12. The method of claim 8, further comprising:
identifying a plurality of delivery vehicles at the FC, wherein the plurality of delivery vehicles comprises a first delivery vehicle and a second delivery vehicle containing at least one FD item;
identifying a first number of FD items on-board the first delivery vehicle and a second number of FD items on-board the second delivery vehicle;
scheduling unloading of the first delivery vehicle prior to unloading of the second delivery vehicle responsive to the first number of FD items on-board the first delivery vehicle exceeding the second number of FD items on-board the second delivery vehicle; and
scheduling unloading of the second delivery vehicle prior to unloading of the first delivery vehicle responsive to the second number of FD items on-board the second delivery vehicle exceeding the first number of FD items on-board the first delivery vehicle.

13. The method of claim 8, further comprising:
generating a FD status indicator associated with an entry for a FD item within an item order page, wherein the FD status indicator identifies the FD item as a temporarily OOS item which is available to order with a delayed future date of delivery.

14. The method of claim 8, further comprising:
presenting a list of a plurality of items available for order via a website;
adding a graphical FD status indicator associated with each FD item in the plurality of items; and
adding a graphical non-FD status indicator associated with each item in the plurality of items that are currently available at the FC.

15. One or more computer storage devices having computer-executable instructions stored thereon, which, upon execution by a computer, cause the computer to perform operations comprising:
receiving an order for a future delivery (FD) item that is temporarily out-of-stock (OOS), wherein the FD item is currently in-transit to a fulfillment center (FC) or scheduled to be placed in-transit to the FC within a threshold time period;
predicting, by a first machine learning (ML) model, a transit time from a source location of the FD item to the FC using lane-specific data associated with a route between the source location and the FC, the lane-specific data comprising historical transit times and dynamic extrinsic data;
generating, by a second ML model, an extended estimated delivery date (EEDD) for the FD item associated with the order using the predicted transit time; and
presenting a delivery notification including the EEDD for the FD item to a user via a user interface (UI) device.

16. The one or more computer storage devices of claim 15, wherein the operations further comprise:
predicting, by a dwell time (DT) machine learning (ML) model, DT for the FD item, wherein the EEDD is calculated using the predicted transit time and the predicted dwell time; and
predicting, by a receiving time (RT) ML model, an RT for the FD item at the FC, wherein the EEDD is calculated using the predicted transit time, the predicted dwell time, and the predicted receiving time.

17. The one or more computer storage devices of claim 15, wherein the operations further comprise:
identifying a first delivery vehicle in a plurality of delivery vehicles at the FC containing at least one FD item; and
prioritizing unloading the first delivery vehicle ahead of a second delivery vehicle in the plurality delivery vehicles, wherein the second delivery vehicle fails to contain any FD items.

18. The one or more computer storage devices of claim 15, wherein the operations further comprise:
identifying a plurality of delivery vehicles at the FC, wherein the plurality of delivery vehicles comprises a first delivery vehicle and a second delivery vehicle containing at least one FD item;
identifying a first number of FD items on-board the first delivery vehicle and a second number of FD items on-board the second delivery vehicle;
scheduling unloading of the first delivery vehicle prior to unloading of the second delivery vehicle responsive to the first number of FD items on-board the first delivery vehicle exceeding the second number of FD items on-board the second delivery vehicle; and
scheduling unloading of the second delivery vehicle prior to unloading of the first delivery vehicle responsive to the second number of FD items on-board the second delivery vehicle exceeding the first number of FD items on-board the first delivery vehicle.

19. The one or more computer storage devices of claim 15, wherein the operations further comprise:
generating a FD status indicator associated with an entry for a FD item within an item order page, wherein the FD status indicator identifies the FD item as a temporarily OOS item which is available to order with a delayed future date of delivery.

20. The one or more computer storage devices of claim 15, wherein the operations further comprise:
presenting a list of a plurality of items available for order via a website;
adding a graphical FD status indicator associated with each FD item in the plurality of items; and
adding a graphical non-FD status indicator associated with each item in the plurality of items that are currently available at the FC.
